(19) United States
(12) Patent Application Publication
(10) Pub. No.: US 2017/0268465 A1
(43) Pub. Date: Sep. 21, 2017

(54) Voltage Calculator and Generator for On-Board Diagnostic System and Method of Using the Same

(71) Applicant: ImageStatistics, Inc., Philadelphia, PA (US)

(72) Inventors: Vikram Agrahar, Philadelphia, PA (US); Joseph Gaetz, Philadelphia, PA (US); Lalit K. Aggarwal, Philadelphia, PA (US)

(21) Appl. No.: 15/509,686

(22) PCT Filed: Oct. 1, 2015
(86) PCT No.: PCT/US15/53482

§ 371 Date: Mar. 8, 2017

Related U.S. Application Data
(60) Provisional application No. 62/058,879, filed on Oct. 2, 2014.

(51) Int. Cl. F02M 25/12; F02D 41/26; F02D 41/20; F02D 41/28

(52) U.S. Cl. CPC F02M 25/12; F02D 41/28; F02D 41/263; F02D 41/20; F02D 2041/281; F02D 2041/2013

(57) ABSTRACT

A system and method are described for providing hydrogen gas to an internal combustion engine based, in part, on selected data retrieved from a vehicle interface to reduce particulate and harmful matter from emissions and improve efficiency.

### CROSS-REFERENCE TO RELATED APPLICATIONS

This international application claims the benefit of U.S. Provisional Application No. 62/058,879, filed Oct. 2, 2014, the entirety of which is incorporated herein by reference.

### FIELD OF THE INVENTION

The present invention relates generally to a system and method for providing hydrogen gas to an internal combustion engine and more particularly, but not exclusively, to a system and method that utilizes data from a vehicle's or engine's interface device or an external data source to optimize the amount of hydrogen to an internal combustion engine to reduce particulate and other harmful matter from emissions and improve engine efficiency.

### BACKGROUND OF THE INVENTION

Combustion engines burn fuel to provide motion. In the process of burning fuel, engines produce exhaust products that are environmentally harmful. One reason for the production of harmful exhaust products lies in incomplete combustion of the fuel within the engine. For example, combustion engines produce particulate matter emissions that may, when not controlled or mediated, cause health hazards.

Attempts have been made to reduce particulate matter, including: performing routine preventative maintenance of engines to minimize emissions; installing aftermarket or retrofit engine exhaust filters; installing cleaner burning engines; installing aftermarket or retrofit oxidation catalysts; and/or using special fuels or fuel additives. However, these attempts have not provided a satisfactory solution to the removal of particulate matter and other harmful exhaust products from combustion exhaust.

The present invention fills a need in the field by disclosing systems and methods for providing controlled amounts of hydrogen to internal combustion engines to improve combustion and thereby reduce the production of harmful exhaust products.

### SUMMARY OF THE INVENTION

In a first aspect, the present invention includes a system for providing hydrogen gas to an internal combustion engine. The system may be configured to communicate with a hydrogen source that provides hydrogen gas to the internal combustion engine in an amount proportional to an applied voltage. The system may include a main processor configured to receive selected data from at least one of a vehicle or engine interface device and an external data source where the main processor may be configured to generate and transmit a processor signal based on the selected data. For example, the main processor may compute a desired voltage to be delivered to an electrolyzer based on a look-up table (LUT) and data obtained from a vehicle's on-board diagnostic (OBD) device or sensors.

The system may also include a pulse width modulation (PWM) processor in communication with the main processor for receiving the processor signal, where the PWM processor may be configured to provide a pulse stream based upon the processor signal. The pulse stream may include a pulse stream time period and a pulse width. Indeed, the main processor may transmit processed data to a PWM processor located elsewhere such as in a vehicle's trunk, engine compartment, or another selected location via a communication bus or wireless method. The main processor may also receive data from the PWM processor regarding a hydrogen source (e.g., an electrolyzer) such as, but not limited to, actual voltage delivered, current rate, gassing rate, temperature, unit temperature, and environment temperature, for example. The main processor may recalibrate the desired output voltage (i.e., applied voltage) to adjust for greater system efficiency and lower particulate emissions.

The main processor may transmit data for statistical logging to peripheral circuit boards that handle data logging and external communications (e.g., communications circuitry). The main processor may receive data from the communications circuitry. The received data may be obtained from a research facility (e.g., a central server) and may include an updated LUT and other formulas that may enhance system performance. The main processor may also get data received from a communications board containing system software updates.

The system of the invention may also include a power driver in communication with the main processor and a power source, with the power driver configured to receive the pulse stream from the PWM processor and increase or decrease the magnitude of a power source voltage to provide an applied voltage to a hydrogen source.

Furthermore, in the system of the invention, at least one of the main processor and the PWM processor may be configured to receive feedback data from a sensor after the provision of an applied voltage to dynamically adjust at least one of the processor signal and the pulse stream during operation of the system.

In another aspect, the invention includes a method for providing hydrogen gas to an internal combustion engine. The method may include the step of acquiring selected data from a vehicle having an internal combustion engine.

The method may further include processing the selected data and comparing the selected data to a look up table to generate a processor signal based on the selected data. The method may also include producing a pulse stream based on the processor signal, with the pulse stream including a pulse stream time period and a pulse width.

The method of the invention may include providing a power source voltage to a power driver and changing the magnitude of the power source voltage based on the pulse stream to provide an applied voltage, wherein changing the magnitude of the power source voltage includes increasing or decreasing the magnitude of the power source voltage. The method may also include providing the applied voltage to a hydrogen source to produce an amount of hydrogen gas proportional to the applied voltage.

Moreover, the method may include receiving feedback data from a sensor, after providing the applied voltage to the hydrogen source, and dynamically adjusting at least one of the processor signal and pulse stream based on the feedback data.

### BRIEF DESCRIPTION OF THE DRAWINGS

The foregoing summary and the following detailed description of the exemplary embodiments of the present invention may be further understood when read in conjunction with the appended drawings, where like elements are numbered alike throughout, in which:

FIG. 1 schematically illustrates a system of the invention that includes a power driver and a hydrogen source that may be an electrolyzer hydrogen generator.

FIG. 2 schematically illustrates a system of the invention having a multi-stage power driver system with a plurality of buck, boost, or buck-boost drivers, depending upon the design of the system and the voltage provided by the driver power source.

FIG. 3 schematically illustrates a system of the invention having a contained hydrogen system as the hydrogen source, wherein a hydrogen actuator is connected to a hydrogen storage tank and the actuator may be opened and closed to provide a selected amount of hydrogen to a vehicle engine.

FIG. 4 schematically illustrates a method of operating a system of the invention.

FIG. 5 schematically illustrates an exemplary vehicle On-Board Diagnostic (OBD) decoder module.

FIG. 6 schematically illustrates an exemplary communication module used in a system of the invention that includes a WiFi transceiver.

FIG. 7 schematically illustrates a low volume hydrogen injection unit controller of the invention.

FIG. 8 schematically illustrates the power driver components of a high volume hydrogen injection unit controller of the invention and, specifically, a power driver module.

FIGS. 9A and 9B schematically illustrate a multiphase main processor (FIG. 9A) and pulse width modulation (PWM) processor (FIG. 9B) components of a high volume hydrogen injection unit controller of the invention.

### DETAILED DESCRIPTION OF THE INVENTION

The disclosed invention is designed to operate in conjunction with devices that provide hydrogen gas to internal combustion engines at the point of combustion, for example, to enhance the burning of fuels. By improving the combustion process, harmful exhaust products (e.g., particulate matter) may be reduced. As used herein, the term “internal combustion engine” may refer to reciprocating engines (e.g., 2-stroke engines, 4-stroke engines, and diesel engines), rotary engines, and continuous combustion engines (e.g., gas turbine engines and jet engines) that convert fuel energy to other forms of energy such as mechanical, electrical and such. Accordingly, an internal combustion engine, as encompassed within the present invention, may include internal combustion engines of any size or fuel type, which may be used in a variety of applications (e.g., electric generators, jet engines, diesel locomotive engines, the engines of three-wheeler rickshaws, and the like).

Devices that generate hydrogen gas include electrolysis devices having a fuel cell connected to a water supply that, upon application of a voltage, produce hydrogen and oxygen. Exemplary devices may be found in U.S. Pat. Nos. 8,449,733; 8,449,734; 8,449,735; 8,449,736; 8,449,754; 8,454,808; 8,499,722; and 8,757,107; each of which is incorporated by reference herein. In the function of such devices, hydrogen gas may be injected into the air intake of the engine to improve combustion. However, there is a need in the field to improve the efficiency of such devices by providing an electronic controller and system that can precisely provide selected amounts of hydrogen to the engine to maximize combustion (e.g., reduce particulate matter) and ensure the efficiency of the system. The present invention meets those needs.

A system of the invention may be connected to a vehicle or an engine to collect data regarding various parameters such as speed, revolutions per minute (RPM), or engine load, through various sensors and connections, such as through the vehicle's or engine's on-board diagnostic (OBD) device or similar vehicle or engine interface device. The system of the invention may translate such information to data that is used for controlling a power amplifier that can energize a load with the appropriate voltage and current to provide a certain amount of hydrogen gas from a hydrogen source. The system of the invention may, in addition, provide real time diagnostic information to an attached computer, allow configurations to be dynamically changed as needed, and allow recording of data onto an onboard storage or remote storage into a database through a wireless connection. The stored information may be used for future analysis.

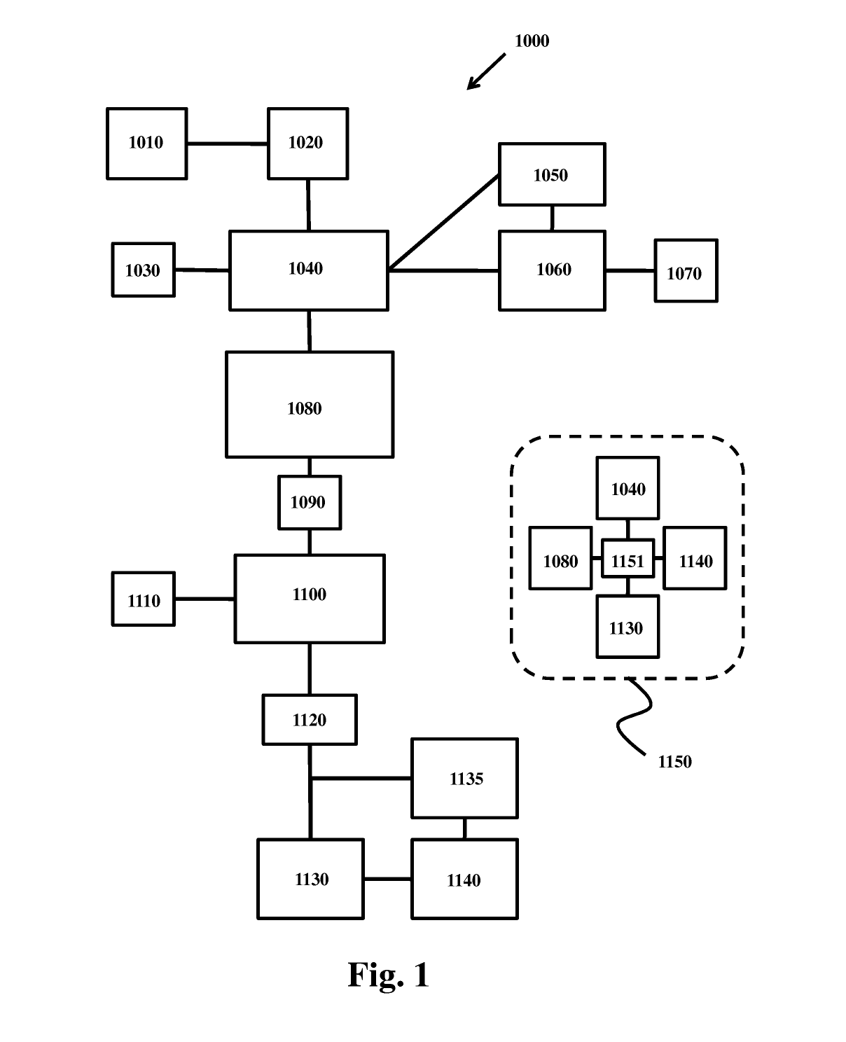

Referring now to the figures, wherein like elements are numbered alike throughout, FIG. 1 illustrates an electronic controller system 1000 that may control the delivery of hydrogen gas to an internal combustion engine. The device 1000 may include a vehicle or engine interface decoder 1020, a main processor 1040, a pulse width modulation (PWM) processor 1080, and a power driver 1100. The system 1000 may receive data from a vehicle or engine interface 1010 (among other data sources), determine the applicable voltage that needs to be applied to a hydrogen source 1130 to produce a selected quantity of hydrogen to an engine 1140, and then apply that voltage to the hydrogen source 1130 to thereby produce the selected quantity of hydrogen proportional to the applied voltage.

In accordance with associated FIGS. 1-3, solid lines connecting elements of the invention may indicate routes of communication between such elements. For example, communication between elements may be electrical communication, optical communication, mechanical communication, fluid communication (e.g., gaseous communication), or any means of communication that allows the indicated elements of the invention to interact by the transmission and/or reception of electromagnetic radiation, radio waves, light, voltage, current, or a combination thereof.

The system 1000 includes main processor 1040 that may receive selected data from a vehicle interface 1010, an external data source (not provided in FIG. 1), or a combination thereof. The main processor 1040 functions as the central hub of the system 1000. The main processor 1040 processes the selected data and compares it to a look-up table (LUT) that may be stored on an electronic storage medium within the main processor 1040. By comparing the selected data to the LUT, the main processor may produce a processor signal and transmit the processor signal to a PWM processor 1080. The main processor may be in communication with a processor power source 1030 that provides power to the main processor 1040.

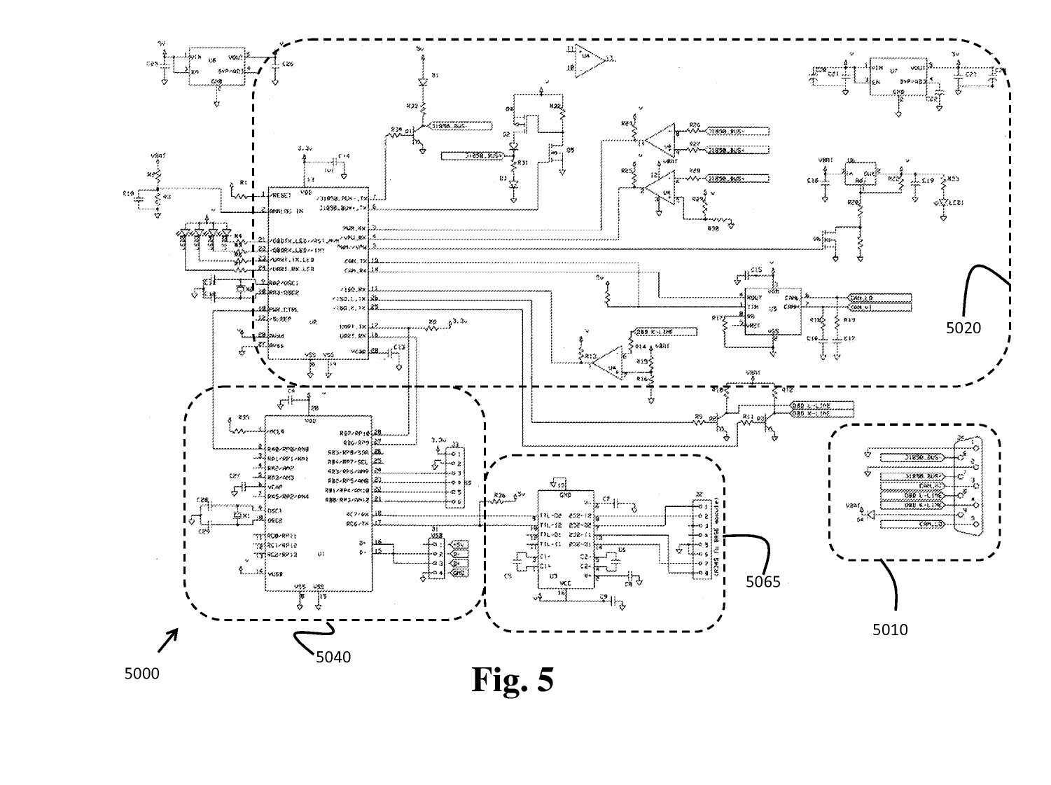

The main processor may communicate with the vehicle interface 1010 directly or, preferably, may communicate with the vehicle interface 1010 through a vehicle interface decoder 1020 that decodes the signals produced by the vehicle interface 1010 and provides a decoded signal to the main processor 1040 that may be read by the main processor 1040. Preferably, the vehicle interface 1010 may be an On-Board Diagnostic (OBD) device such as an OBD-II. Additionally, the vehicle interface decoder 1020 is preferably an OBD decoder. An exemplary OBD decoder is set forth in FIG. 5.

The main processor 1040 may store settings of the system for reference, accept changes to such settings, query the vehicle interface decoder for status, data and other status questions, provide data to other sections, provide logging data, pulse width modulation related data, and/or boot up sequences.

The main processor 1040 may check for vehicle interface connectivity by communicating with the vehicle's interface port (e.g., OBD interface port) located in the passenger cabin of a vehicle.

For example, the system 1000 may include an OBD decoder that may connect to an industry standard interface OBD bus. The standard interface OBD bus may have a typical J1962 connector. In automotive devices, certain automobiles may have a variant of the connector. The OBD decoder circuit may use an off the shelf, commercially available chip, as would be understood by those having ordinary skill in the art, that translates the received OBD data from the automobile into serial data for further processing. The OBD decoder circuit may accept a request for information from the system and further may request it from the OBD bus and may receive replies from the OBD bus for translation.

The external data source may be a user interface that can transfer data to the main processor 1040 or may be an external server that can remotely provide data to the main processor 1040 through communication circuitry 1060 having a transceiver 1070. As used herein, a “transceiver” may be a device having both a transmitter and a receiver that is capable of transmitting and receiving data, simultaneously or alternatively, where data is transmitted and received through electrical communication, electromagnetic communication, optical communication, or a combination thereof.

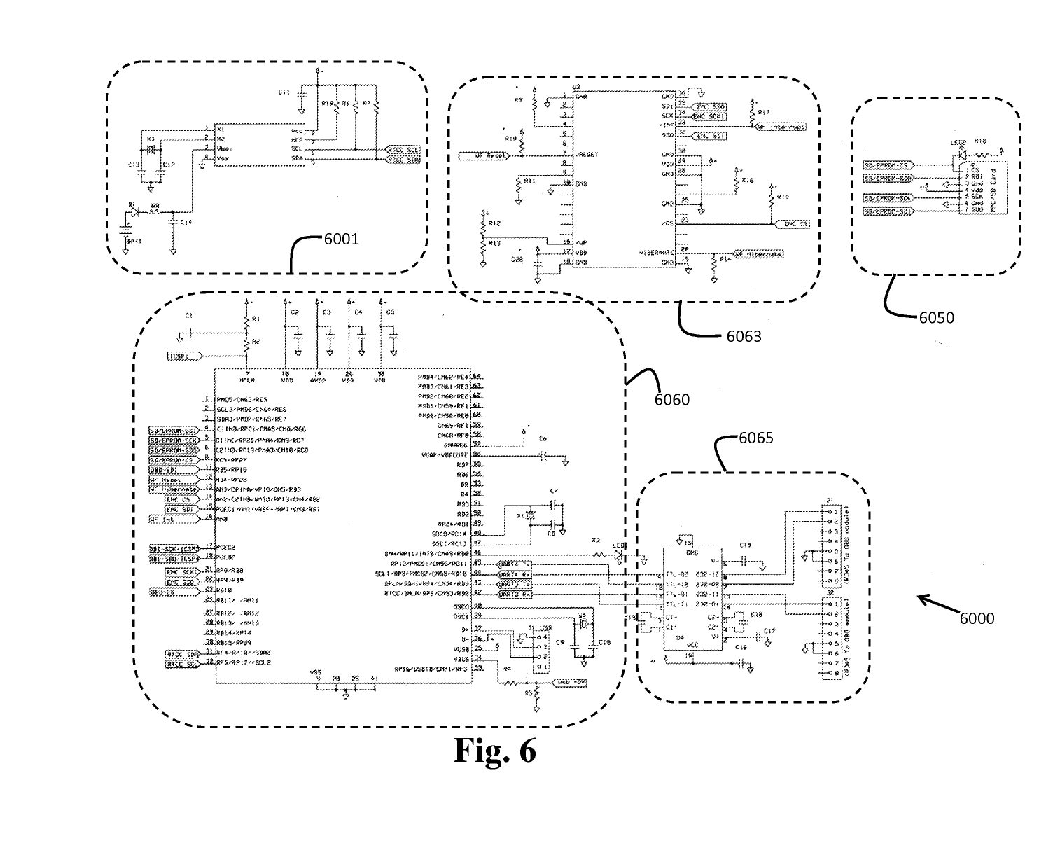

The communication circuitry 1060 may receive data from the main processor 1040 with statistical and logging data. The communications circuitry 1060 may further scan for connectivity to a central server via various communication methods such as, for example, Bluetooth, WiFi, and cellular communication methods. An exemplary communication circuit of the invention is set forth in FIG. 6 having a WiFi transceiver. The communication circuitry 1060 may further upload data to the central servers via a secure and encrypted method after connectivity to a server is detected. The communication circuitry 1060 may delete data from onboard memory once data written to the server is confirmed. The communication circuitry 1060 may also transmit data such as its own identification, serial number, and/or similar data to the server. The communication circuitry 1060 may also include a GPS receiver.

Additionally, the communication circuitry 1060 can also seek and obtain a communication link via an approved communication node. The communications circuitry 1060 may communicate via known wireless interfaces, such as, WiFi, cellular, Industrial Scientific and Medical (ISM), and other radio systems, for example.

The communication circuitry 1060 may check for any data to be received by the main processor 1040 from the central servers. The communication circuitry 1060 may download data, software updates, and/or similar data if available from the central server. The communication circuitry 1060 may transmit data to the main processor 1040 after receiving data from the central server. Additionally, the communication circuitry 1060 may have a real time clock (RTC) to keep track of real world time, where such RTC may have a long life battery to keep the RTC active even when external power is unavailable. The communication circuitry 1060 may check periodically when connectivity to the server is available for current time to recalibrate the RTC for any drifts in the RTC are detected.

The external data source may provide external data to the main processor 1040 where such external data may include, for example, fixed variables, types of data that may be excluded from processing, time, and/or user preferences. The external data received from the external data source may also include software upgrades for software that may be used by the main processor 1040 or PWM processor 1080. The external data may also include LUTs, updated LUTs, or replacement LUTs. Optionally, the transceiver 1070 may be replaced by a receiver that may receive a signal. Furthermore, the transceiver 1070 may receive selected data from, for example, the external server (e.g., a central server). The transceiver 1070 may also transmit the selected data received by the main processor 1040 and/or feedback data produced by other sensors of the system of the invention to the external server for recordation and review.

As used herein, “selected data” may include, but is not limited to, a vehicle temperature, a vehicle pressure, vehicle speed, an environmental temperature, an environmental pressure, time, a vehicle status, or a combination thereof. More particularly, the “selected data” may include, but is not limited to, fuel system status, engine load, engine coolant temperature, short term fuel percent trim, long term fuel percent trim, fuel pressure, intake manifold absolute pressure, engine RPM, vehicle speed, timing advance, intake air temperature, MAF air flow rate, throttle position, oxygen sensor data, run time since engine start, distance traveled with malfunction indicator lamp on, fuel rail pressure, fuel level, barometric pressure, evaporation system vapor pressure, catalyst temperature, ambient air temperature, accelerator pedal position, fuel type, ethanol fuel percent, hybrid battery pack data, fuel injection timing, engine oil temperature, engine torque data, air flow data, diesel intake air flow control and relative intake air flow position, exhaust gas recirculation temperature, exhaust pressure, turbocharger RPM, turbocharger temperature, charge air cooler temperature, exhaust gas temperature, diesel particulate filter temperature, engine run time, or a combination thereof. Preferably, the “selected data” may include, but is not limited to, engine RPM, engine load, vehicle speed, oxygen sensor data, or a combination thereof. As used herein, “oxygen sensor data” refers to data from an oxygen sensor that is located on the vehicle (e.g., on a surface of the vehicle exterior to the engine 1140 or interior to the engine 1140), where such data indicates the oxygen concentration at or about the oxygen sensor.

The system 1000 may also include recording circuitry 1050 that may be in communication with one or both of the main processor 1040 and communication circuitry 1060. The recording circuitry 1050 may record system data (e.g., data produced by an element of the system 1000) and/or external data onto a non-transitory storage medium. Storage media for containing data include, for example, floppy disks and diskettes, compact disk (CD)-ROMs (whether or not writeable), DVD digital disks, RAM and ROM memories, SD cards, computer hard drives and back-up drives, external hard drives, “thumb” drives, and any other storage medium readable by a computer.

Furthermore, the recording circuitry 1050 may communicate with the main processor 1040 to periodically collect logging data (e.g., system data). The recording circuitry 1050, in addition to storage, can also accept commands for requests of data. The recording circuitry 1050 may hold configuration data. Moreover, the recording circuitry 1050 may handle data for upgrading the firmware of sections of the system or update communication related information.

The system 1000 may further include a PWM processor 1080 that may receive and decode the processor signal from the main processor 1040. The PWM processor 1080 may convert the processor signal that is based upon the LUT to provide a pulse stream. The pulse stream produced by the PWM processor 1080 has both a pulse stream time period and a pulse width, where both the pulse stream time period and the pulse width may be modified by varying the processor signal from the main processor.

Additionally, the PWM processor 1080 may take active measurements of the voltage and/or current at the load to provide a stable output. The PWM processor may use the active measurements of the output to recalculate the time period for the pulse stream and/or the width of each pulse in the pulse stream to dynamically track and correct the pulse period and width.

The PWM processor 1080 may also check for fault in the system 1000 such as overheating of power drivers, potential short circuit, overload in a circuit, power issues in the power supply, communication disruption from the main processor, and/or safe start up and shutdown of the device and provide logging information to the main processor 1040.

The pulse stream produced by the PWM processor 1080 may be selected to produce a selected output at the power driver 1100. In the system 1000, the PWM processor 1080 may communicate directly with the power driver 1100 or, for example, may be connected to the power driver 1100 through a preamplifier 1090. The preamplifier 1090 may allow the PWM processor 1080 to provide an amplified pulse stream to the power driver 1100. Indeed, the preamplifier 1090 may be an electronic amplifier that provides an electrical signal to reduce the effects of noise and interference by boosting the signal strength of the pulse stream, and increasing the signal-to-noise ratio.

The PWM processor 1080 may receive several environmental sensor outputs such as, but not limited to, actual voltage delivered, current rate, gassing rate, temperature, unit temperature, and environment temperature. The PWM processor 1080 may use the foregoing sensor outputs for immediate corrections, emergency shutoff, or similar functions. The PWM processor 1080 may transmit such sensor outputs back to the main processor 1040.

The system may include a power driver 1100 that may receive the pulse stream from the PWM processor 1080 and is in communication with a driver power source 1110. The driver power source 1110 provides a power source voltage to the power driver 1100.

The processor power source 1030 and/or driver power source 1110 may include a battery (e.g., the battery of the vehicle upon which the system 1000 is deployed or an independent battery for the system 1000), a DC generator (e.g., solar generator, wind generator, gas powered generator), another power source derived from the vehicle upon which the system 1000 is deployed (e.g., an alternator of the vehicle), a transmission line, or a combination thereof. The term battery is used herein to refer to an electro-chemical device comprising one or more electro-chemical cells and/or fuel cells, and so a battery may include a single cell or plural cells, whether as individual units or as a packaged unit. A battery is one example of a type of an electrical power source suitable for a portable device.

The power source voltage may be less than 100 volts. Preferably, the power source voltage is less than 50 volts. More preferably, the power source voltage is about 10 volts to 25 volts. In certain aspects, the power source voltage is 12 volts or 24 volts.

The power driver 1100, in response to the received pulse stream, may increase or decrease the magnitude of the power source voltage to produce an applied voltage. The power driver 1100 may be a buck driver, a boost driver, or a buck-boost driver. A buck driver may “step-down” or decrease the power source voltage based on the received pulse stream to provide an applied voltage that is lesser in magnitude than the power source voltage. For example, where the power source voltage is about 24 volts, the buck driver may step-down the voltage to a value that is between 0 and 24 volts. A boost driver may “step-up” or increase the power source voltage based on the received pulse stream to provide an applied voltage that is greater in magnitude than the power source voltage. For example, where the power source voltage is 24 volts, the boost driver may step-up the voltage to a value greater than 24 volts and, preferably, a value that is between 24 and 50 volts. A buck-boost driver may switch between buck and boost mode based on the application of the received pulse stream.

Indeed, the PWM processor 1080 may provide a pulse stream to the power driver 1100 to provide voltages lesser than and/or greater than the supply commonly called the buck-boost system. The PWM processor 1080 may seamlessly switch between the buck mode and the boost mode where the power driver 1100 includes both a buck driver and a boost driver. Alternatively, a buck system or boost system may be provided rather than the two in combination.

For example, the power driver 1100 may include a MOSFET or a transistor drive, diodes, or a combination of similar components, a selection of filter components such as inductors, capacitors in a calculated combination for a target load device. The selection of the components requires knowledge of the target load device's characteristics with multiple components to allow the drive stage to generate a voltage below the supply level or above the supply level known as a buck mode or boost mode, respectively.

The power driver 1100 may include an internal protection circuit that will protect the system from, for example, overvoltages or back EMF voltages. The power driver 1100 may also deliver power to a filter network 1120, such as, for example, an LC filter network that may include capacitors and inductors.

The filter network 1120 may perform a smoothening function based on the LC value combination that will provide, for example, a DC voltage at a voltage calculated by the main processor 1040.

Furthermore, the PWM processor 1080 may sense the voltage at the output of the filter network 1120 (e.g., LC filter output) via a filter sensor to instantaneously correct any drifts or any other compensations that may be required via a closed feedback loop. The PWM processor 1080 may also transmit the voltage at the LC filter output to the main processor 1040 for recalibration of the calculation used for production of the processor signal, as needed. An LC filter at the PWM processor 1080 may have an output that is delivered to a hydrogen source 1130 for hydrogen production. Preferably, the power driver 1100 provides the applied voltage to the filter network 1120, which thereby provides the applied voltage, now filtered, to the hydrogen source 1130.

Hydrogen source 1130 of the invention may include an electrolyzer hydrogen source, such as, for example, an electrolytic hydrogen generator as described in U.S. Pat. Nos. 8,449,733; 8,449,734; 8,449,735; 8,449,736; 8,449,754; 8,454,808; 8,499,722; and 8,757,107; each of which is incorporated by reference herein. The electrolyzers described in the foregoing disclosures produce a selected amount of hydrogen and oxygen upon the application of a voltage. Consequently, the present system 1000 may modulate the amount of hydrogen produced by varying the applied voltage, as set forth herein.

The foregoing hydrogen source 1130, which may be in communication with the power driver 1100 either directly or through the filter network 1120, may then be in gaseous communication with the engine 1140. Accordingly, hydrogen gas originating at the hydrogen source may be injected into the air intake of the engine (or to a combustion chamber of the engine) to enhance combustion.

The system 1000 may further include a safety module 1135 that may monitor the overall operation of the system 1000 that, in case of an accident or failure, as a whole or in part, of the system 1000, the safety module 1135 may halt the production of hydrogen and/or vent any hydrogen stored by the system at the hydrogen source 1130 or engine 1140 to the atmosphere. The safety module 1135 may be in communication (e.g., electrical and/or fluid communication) with at least one of the hydrogen source 1130 and engine 1140. Additionally, the safety module 1135 may be in communication with one or more sensors 1151 and may have circuitry to receive a fault signal from the one or more sensors 1151 that may cause the safety module 1135 to halt the production of hydrogen and/or vent any hydrogen stored by the system at the hydrogen source 1130 or engine 1140 to the atmosphere. In certain aspects of the invention, the safety module 1135 may be a valve in line with the hydrogen source 1130 and engine 1140 configured to prevent back flow, vent hydrogen stored at the hydrogen source 1130, and halt the production of hydrogen to the engine 1140.

In certain preferred embodiments, the safety module 1135 may be a fail-safe valve, that halts the production of hydrogen and/or vents any hydrogen stored by the system at the hydrogen source 1130 in case of an accident or malfunction of the system 1000.

Additionally, the system 1000 may also utilize one or more sensors 1151 in communication with main processor 1040, PWM processor 1080, hydrogen source 1130, and/or engine 1130, as demonstrated in sensor network 1150. The sensor network 1150 allows for a sensor 1151 to provide information to the main processor 1040 and/or PWM processor 1080. Preferably, the one or more sensors 1151 may be a hydrogen source power sensor, a current rate sensor, a gas rate sensor, a hydrogen source temperature sensor, a hydrogen source unit sensor, an output voltage sensor, hydrogen concentration sensor, or a combination thereof. For example, sensor 1151 may include a hydrogen source power sensor that provides data output describing the power provided to the hydrogen source in real time. A current rate sensor may include one or more sensors that provide data output describing the current at the processor power source 1030, driver power source 1110, power driver 1100, or hydrogen source 1130, for example. A gas rate sensor may include one or more sensors placed at the hydrogen source 1130 or engine 1140 to determine the rate and concentration of hydrogen provided from the hydrogen source 1130 to the engine 1140. Additionally, a gas rate sensor may be provided at the exhaust of the engine 1140 to determine the amount of hydrogen that is being exhausted and not combusted. A hydrogen source temperature sensor may be provided at the hydrogen source 1130 to determine the temperature of the hydrogen source 1130. A hydrogen source unit sensor may be provided at the hydrogen source 1130 to provide data output indicating whether the hydrogen source 1130 is functioning and, for example, whether there is a sufficient quantity of water at the hydrogen source 1130 when the hydrogen source 1130 includes an electrolyzer. An output voltage sensor may include one or more sensors that provide data output describing the voltage at the processor power source 1030, driver power source 1110, power driver 1100, or hydrogen source 1130, for example. The system 1000 may also include a hydrogen concentration sensor that, in combination with the gas rate sensor, may provide a data output that indicates the concentration of hydrogen gas after production by the hydrogen source 1130.

The foregoing sensors 1151 in the sensor network 1150 provide feedback data on the operation of the system 1000 to the main processor 1040 and/or PWM processor 1080. The main processor 1040 and/or PWM processor 1080 include processor circuitry that allows for the processing of the selected data in conjunction with the feedback data to dynamically adjust the processor signal, pulse stream, and/or LUT in real time to optimize the operation of the system 1000. For example, if a gas rate sensor at the exhaust of the engine 1140 indicates that the hydrogen provided to the engine 1140 is not completely combusting, the main processor can dynamically adjust the LUT and processor signal to produce an applied voltage at the power driver 1100, which results in a decreased production of hydrogen at the hydrogen source 1130.

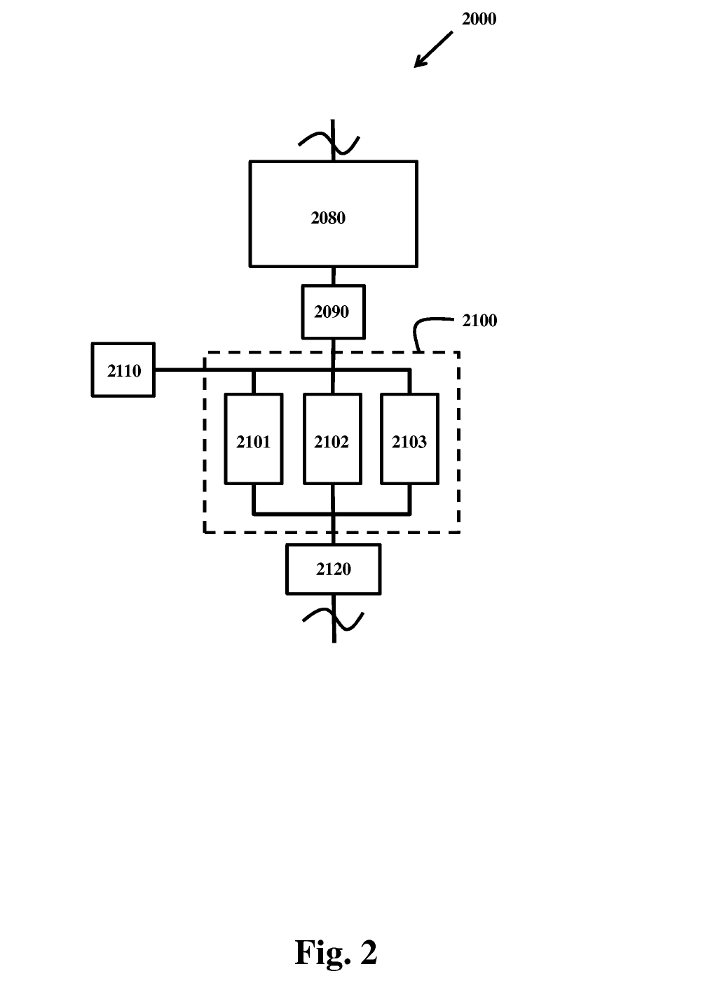

In an alternative embodiment as set forth in FIG. 2, a system 2000 of the invention may have a multiphase power driver system wherein the PWM processor 2080 may synchronously operate multiple PWM signals in such a way that it can power up multiple power driver stage units such as those provided in the power driver 2100, which provides a plurality of power drivers 2101, 2102, 2103 in parallel to allow a cooler operation of the system. This is a multi-phase PWM system. The PWM processor 2080 may also operate a cooling fan, when required, to keep the power drive stage and related components at a stable temperature. Furthermore, similar to other systems of the invention, the PWM processor 2080 may be connected to the power driver 2100 through a preamplifier 2090.

Furthermore, the power driver 2100 operates the multiple power drive stages in parallel by operating under a multiphase mode. The power driver 2100 is connected to a driver power source 2110. This allows for the driving of multiple power drivers (e.g., 2101, 2102, 2103) in a timed manner to distribute the amount of power passing through each power drive stage to allow a much higher operating power range and further allow the power drive stage to remain at a lower temperature. This allows the system 2000 to be power efficient. Power drivers 2101, 2102, and 2103 may be buck drivers, boost drivers, or buck-boost drivers. When operating in a multiphase mode, the filter network 2120 collects the increased or decreased voltage produced by the plurality of power drivers 2100 and smooths the applied voltage to provide an applied voltage to the hydrogen source (e.g., hydrogen source 1130).

Other advantages of the multistage driver system include synchronization of the plurality of drivers and low ripple current output.

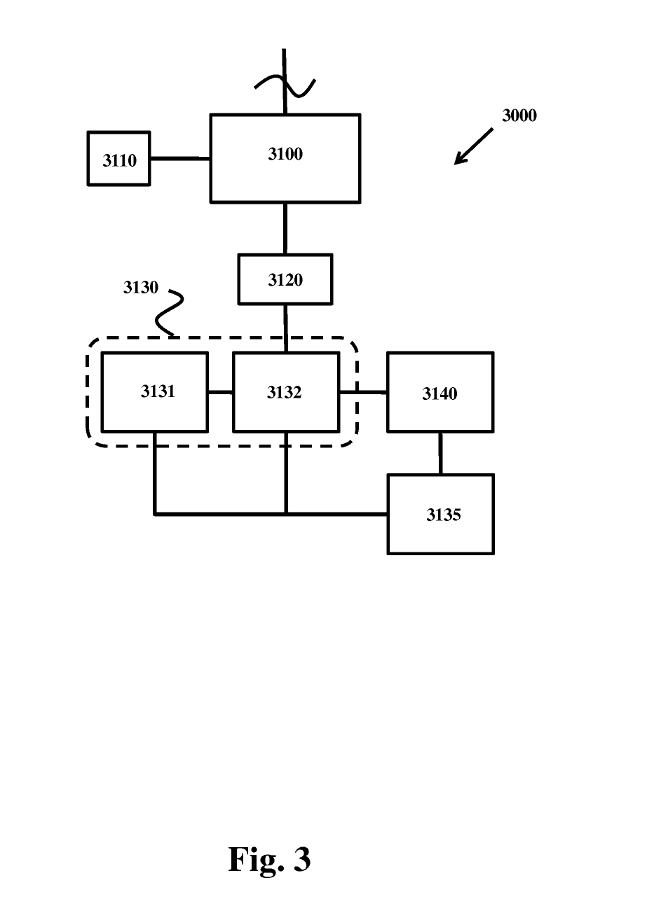

In an additional aspect of the invention as set forth in FIG. 3, a system 3000 of the invention may include a hydrogen source 3130 having a hydrogen storage container 3131. The storage container 3131 may contain a volume of hydrogen gas. The hydrogen source actuator 3132 may include a valve that opens in response to an applied voltage. Therefore, a system 3000 that includes a quantity of hydrogen in the hydrogen storage container 3131 may deliver hydrogen gas to an engine 3140 upon delivery of the applied voltage to the hydrogen source actuator 3132. For example, the hydrogen source actuator 3132 may be designed to hold the valve to the hydrogen storage container 3131 open for a time proportional to the magnitude of the applied voltage. Furthermore, such a system 3000, as set forth in other systems of the invention, may include a power driver 3100 in communication with a driver power source 3110. The power driver 3100 may then communicate with the hydrogen source actuator 3132 through the filter network 3120.

The system 3000 may further include a safety module 3135 that may monitor the overall operation of the system 3000 that, in case of an accident or failure, as a whole or in part, of the system 3000, the safety module 3135 may halt the production of hydrogen to the engine 3140 and may vent hydrogen stored at the hydrogen storage container 3131, the hydrogen source actuator 3132, and/or engine 3140 to the atmosphere. The safety module 3135 may be in communication (e.g., electrical and/or fluid communication) with at least one of the hydrogen storage container 3131, the hydrogen source actuator 3132, and engine 3140. Additionally, the safety module 3135 may be in communication with one or more sensors (e.g., one or more sensors 1151) and may have circuitry to receive a fault signal from the one or more sensors that may cause the safety module 3135 to halt the production of hydrogen and/or vent any hydrogen stored by the system at the hydrogen storage container 3131, the hydrogen source actuator 3132, and/or engine 3140 to the atmosphere. In certain aspects of the invention, the safety module 3135 may be a valve in line with the hydrogen storage container 3131, the hydrogen source actuator 3132, and engine 3140 configured to both vent hydrogen stored at the hydrogen storage container 3131 and halt the production of hydrogen to the engine 3140.

In certain preferred embodiments, the safety module 3135 may be a fail-safe valve, that halts the production of hydrogen and/or vents any hydrogen stored by the system at the hydrogen source 3130 in case of an accident or malfunction of the system 3000.

The systems of the invention may further include, or be in communication with, a central data facility that includes the central server system and may include a collection of servers that provide an information database, authentication server, and report generation service. The central server may always be on to receive data for a system of the invention. The central server may receive packets of data from the communication server and may log a unique identification, data, and timestamps into the database for a system of the invention.

The central server may include a database that is available for analysis by the end user or operator. The central server may also host updates and calibration values for each unit in operation.

In additional aspects, the systems of the invention (e.g., 1000, 2000, 3000) may include a display for displaying system data and information regarding the operation of the system to a user. The systems of the invention may include a user interface and may allow for a user to program aspects of the system either through a direct connection to the system or remotely. The systems of the invention may also include a power on/off switch to allow a user to disengage the system. The systems of the invention may include a housing for enclosing the components of the system within the housing. The housing may be located within a compartment of a vehicle.

Furthermore, the system of the invention may be enclosed or prepared from such materials known in the art that it may be operated in different environmental systems including under-water, on-board a vehicle, in a cold climate, in a hot climate, on earth, in space, or on an extraterrestrial body.

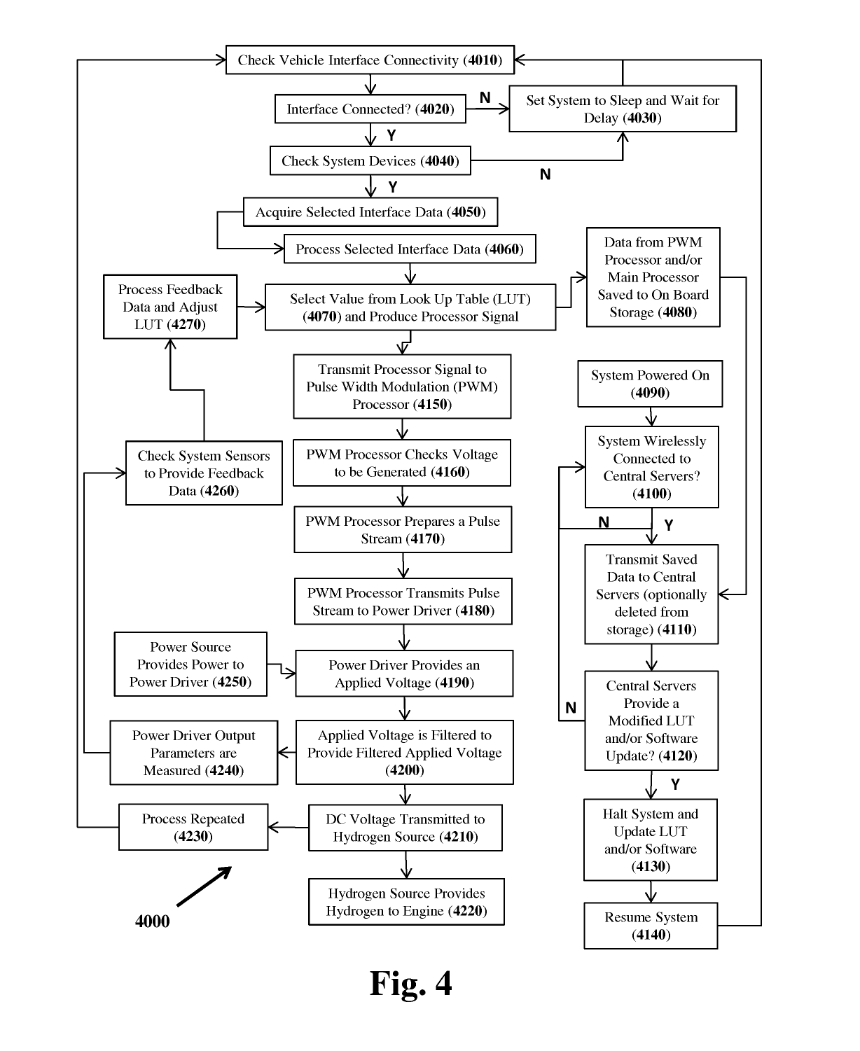

The present invention also includes a method of use 4000 as demonstrated in FIG. 4.

In the exemplary method 4000, a system for providing hydrogen gas to an internal combustion engine is provided. The system may be powered on (step 4090) when the engine of a vehicle is powered on and the system of the invention may check for connectivity to the vehicle interface (e.g., OBD device) (step 4010). Alternatively, activation of the system may be delayed for a selected period of time by a user. If the system is connected to the vehicle interface (step 4020), the system may check devices connected to the system (e.g., main processor, PWM processor, power drivers) (step 4040). If the system is not connected to the vehicle interface (step 4030), the system of the invention may be set to sleep at the main processor and may wait to check for vehicle interface connectivity after a programmed delay.

After checking for, and confirming the connectivity of, the devices connected to the system, the system may acquire selected data from the vehicle interface (step 4050) and then process the selected data from the vehicle interface (step 4060), which may include decoding the data from the vehicle interface to prepare such data for analysis and processing by the main processor. At this stage, the system may also receive selected data from an external data source. After processing, the main processor may compare the selected data from the vehicle interface (and/or external data source) to a look up table (LUT) to determine the value of a processor signal that should be sent to the PWM processor to achieve a desired applied voltage that results in an amount of hydrogen gas being delivered to the engine (step 4070). Additionally, if there is feedback data being provided by sensors of the system (step 4270), the feedback data may be processed with the selected data to dynamically adjust the LUT and/or the processor signal being provided to the PWM processor.

Moreover, selected data, feedback data, system data from the PWM processor, and/or system data from the main processor may be saved to an on-board storage medium (step 4080). After the system is powered on (step 4090), the system may determine if it is wirelessly connected to a central server or in communication with an external receiver (step 4100). If the system is not in communication with a central server or external receiver, it may continue to check for such connectivity after a programmed delay. However, if the system finds connectivity with a central server, for example, the system may transmit saved selected data, feedback data, and/or system data to the central server (step 4110). After transmission of the saved data, the system may delete such data from the on-board storage medium.

In addition, the system of the invention may communicate with a central server, for example, to determine if there is a modified LUT, replacement LUT, and/or software update available for download (step 4120). If no such modified LUT, replacement LUT, or software update is available, the system may continue operation and may repeat the process steps 4100, 4110, and 4120. If there is a modified LUT, replacement LUT, and/or software update available, the system may halt operation and may update the LUT and/or software (step 4130). Upon completion of the update, the system may resume (step 4140).

Turning to the continued operation of the system, after production of the processor signal, the main processor transmits the processor signal data to the PWM processor (step 4150). The processor signal may be transmitted from the main processor to the PWM processor through electrical transmission, radio transmission, optical transmission, cellular transmission or a combination thereof.

The PWM processor decodes the digital processor signal and checks the voltage to be generated by a power driver (step 4160). The PWM processor then prepares a pulse stream based upon the processor signal having a pulse stream period and a pulse width selected to produce an applied voltage by a power driver (step 4170). The pulse stream is then transmitted from the PWM processor to the power driver (step 4180). The pulse stream may be transmitted directly to the power driver or, preferably, may be transmitted via a preamplifier that amplifies the pulse stream before reception by the power driver. Accordingly, step 4180 may further include the step of amplifying the pulse stream to reduce the signal-to-noise ratio.

A power source may communicate a power source voltage to the power driver, with the communicated voltage being less than about 50 volts, but, preferably, about 10 to 25 volts (step 4250). The power driver may then provide based on the pulse stream from the PWM processor to provide an applied voltage (step 4190). In certain aspects, the power pulse stream, based on the pulse stream from the PWM processor, may result in an applied voltage that is greater in magnitude than the power source voltage (i.e., a boost driver system). Alternatively, the power stream, based on the pulse stream from the PWM processor, may result in an applied voltage that is lesser in magnitude than the power source voltage (i.e., a buck driver system).

Alternatively, the applied voltage may be filtered with a filter network (step 4200) to provide a filtered applied voltage. The output power pulse stream and/or applied voltage produced by the power driver may be sensed by a sensor at the power driver (step 4240) and the output parameters associated with the power driver may be converted to feedback data by a sensor network (step 4260). Indeed, the method of the invention may include a step of sensing at least one of a hydrogen source power signal, a current rate signal, a gas rate signal, a hydrogen source temperature signal, a hydrogen source unit signal, an environment temperature signal, an output voltage signal, and a hydrogen concentration signal, where such signals may be converted into feedback data that may be processed at the main processor or PWM processor.

The applied voltage may then be transmitted to a hydrogen source (step 4210) designed to receive the voltage and provide an amount of hydrogen to an internal combustion engine that is proportional to the applied voltage (step 4220). The hydrogen source may be an electrolyzer as described above, or may include a hydrogen gas actuator in fluid communication with a hydrogen gas storage container, wherein the gas actuator may open and release an amount of hydrogen from the hydrogen gas storage that is proportional to the applied voltage.

Additionally, after the applied voltage is transmitted to the hydrogen source (step 4210), the process may be repeated (step 4230) by again checking the vehicle interface connectivity (step 4010).

Moreover, the method of the invention may further include the steps of detecting a fault signal at any sensor that indicates the occurrence of an accident or malfunction of a system of the invention, and transmitting the fault signal to a safety module operably associated with the hydrogen source and/or the engine to, upon reception of the fault signal, halt the production of hydrogen to the engine and/or vent hydrogen stored at the system of the invention (e.g., at the hydrogen source) to the atmosphere.

The present arrangement of method steps may be embodied as a computer implemented process or processes and/or apparatus for performing such computer-implemented process or processes, and can also be embodied in the form of a tangible storage medium containing a computer program or other machine-readable instructions (herein “computer program”), wherein when the computer program is loaded into a computer or other processor (herein “computer”) and/or is executed by the computer, the computer becomes an apparatus for practicing the process or processes. Storage media for containing such computer program include, for example, floppy disks and diskettes, compact disk (CD)-ROMs (whether or not writeable), DVD digital disks, RAM and ROM memories, computer hard drives and back-up drives, SD cards, external hard drives, “thumb” drives, and any other storage medium readable by a computer. The process or processes can also be embodied in the form of a computer program, for example, whether stored in a storage medium or transmitted over a transmission medium such as electrical conductors, fiber optics or other light conductors, or by electromagnetic radiation, wherein when the computer program is loaded into a computer and/or is executed by the computer, the computer becomes an apparatus for practicing the process or processes. The process or processes may be implemented on a general purpose microprocessor or on a digital processor specifically configured to practice the process or processes. When a general-purpose microprocessor is employed, the computer program code configures the circuitry of the microprocessor to create specific logic circuit arrangements. Storage medium readable by a computer includes medium being readable by a computer per se or by another machine that reads the computer instructions for providing those instructions to a computer for controlling its operation. Such machines may include, for example, a punched card reader, a magnetic tape reader, a magnetic card reader, a memory card reader, an optical scanner, as well as machines for reading the storage media mentioned above.

Without limiting the invention in any way, the invention may be described further in the following examples.

### Examples

### Example 1: Exemplary Components Including an On-Board Diagnostic (OBD) Decoder Module and a Communication Module

As shown in FIG. 5, an OBD Decoding module 5000 is provided having an OBD Decoder 5020 connected to a microprocessor 5040 and a communication transceiver 5065. The OBD Decoder 5020 is connected to a vehicle interface 5010 that allows for the connection between the OBD Decoder 5020 and a vehicle's On-Board Diagnostic system.

As shown in FIG. 6, a communication module 6000 is provided having a real time clock 6001, a WiFi transceiver 6063, an on-board storage system 6050, and a communication transceiver 6065 connected to communication circuitry 6060. Communication circuitry 6060 is connected to microprocessor 5040 through the communication transceiver 6065, which allows for communication between the OBD module 5000 and the communication module 6000.

### Example 2: A Low Volume Hydrogen Gas System

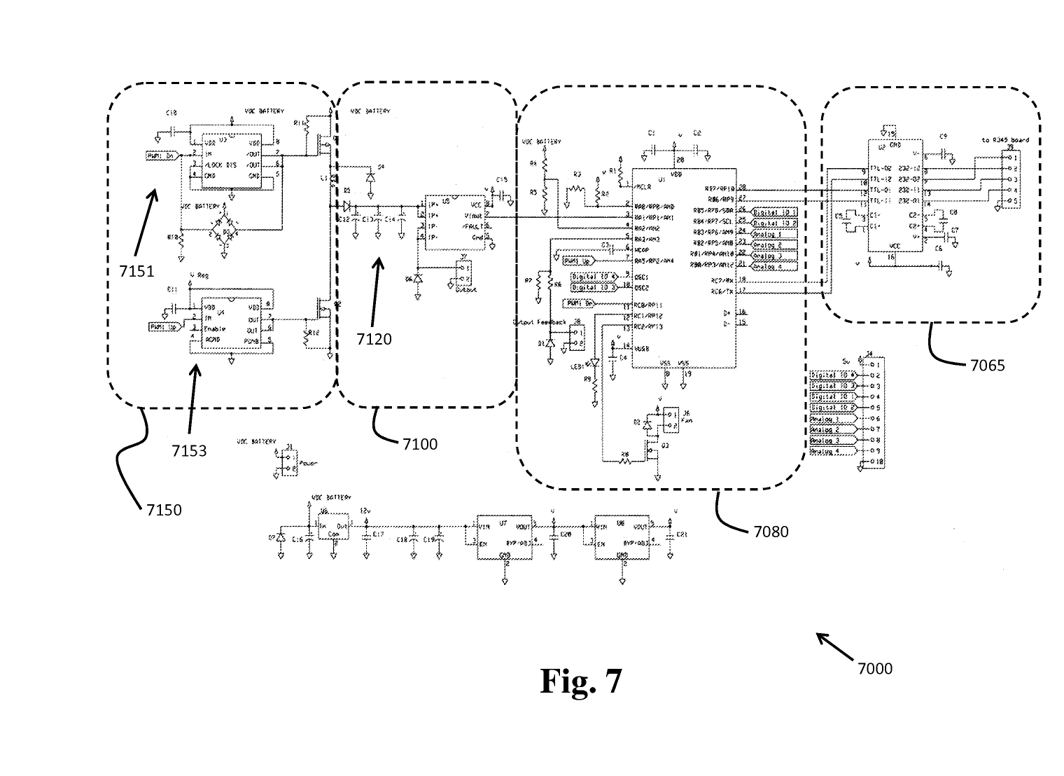

A Low Volume Hydrogen Gas system 7000, used primarily for cars, is provided in FIG. 7. The Low Volume system 7000 includes a buck-boost power driver. Specifically, the Low Volume system 7000 includes a communication transceiver 7065 and a power driver 7150 connected to a pulse width modulation (PWM) processor 7080 through filter/sensor circuitry 7100. The filter/sensor circuitry 7100 includes a filter network 7120. The power driver 7150 has a buck driver 7151 and a boost driver 7153. The Low Volume system 7000 is further connected to a 12 V power source. As described herein, the power driver 7150 can step-down (via the buck driver 7151) or step-up (via the boost driver 7153) the 12 V voltage from the power source to provide an applied voltage to a hydrogen source connected to the Low Volume system.

### Example 3: A High Volume Hydrogen Gas System

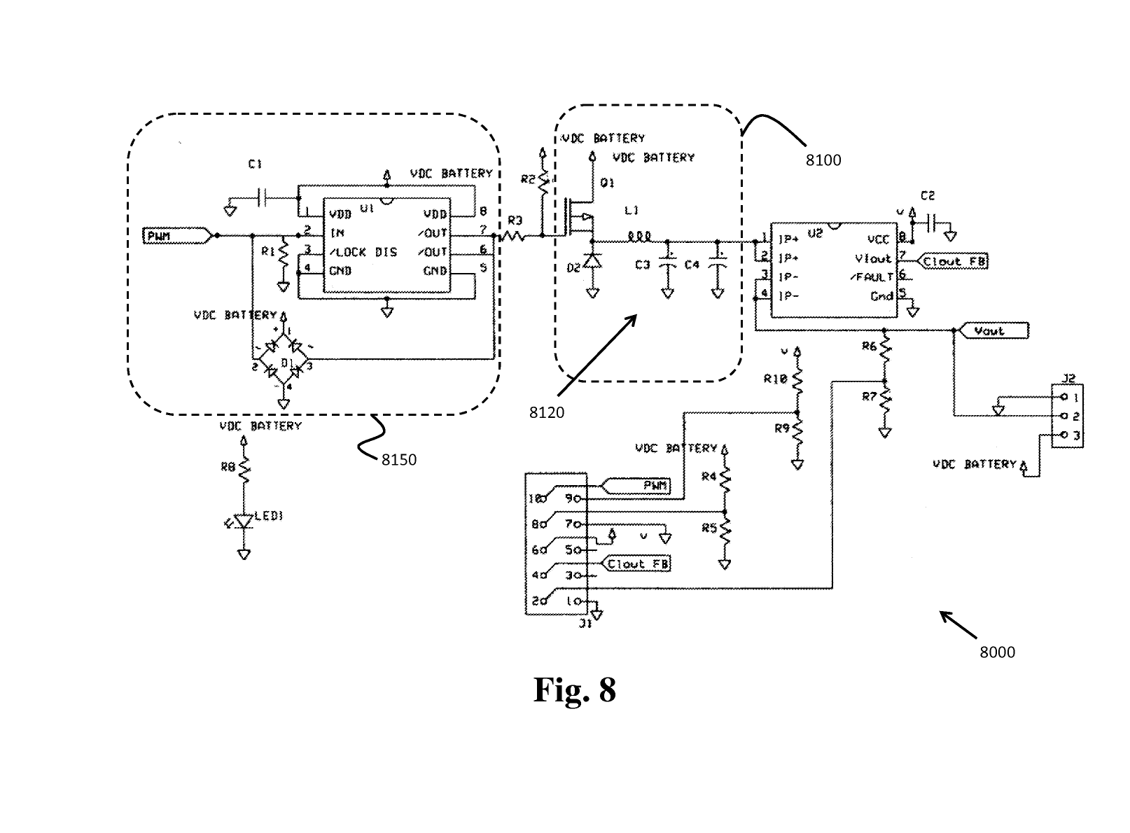

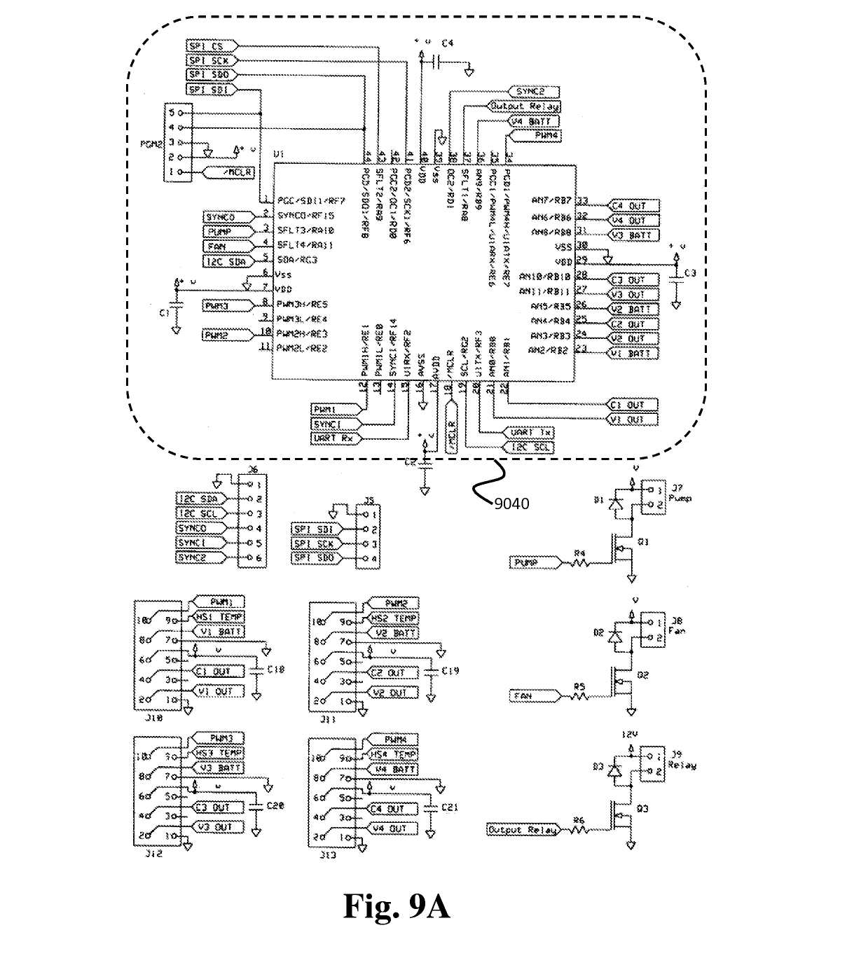

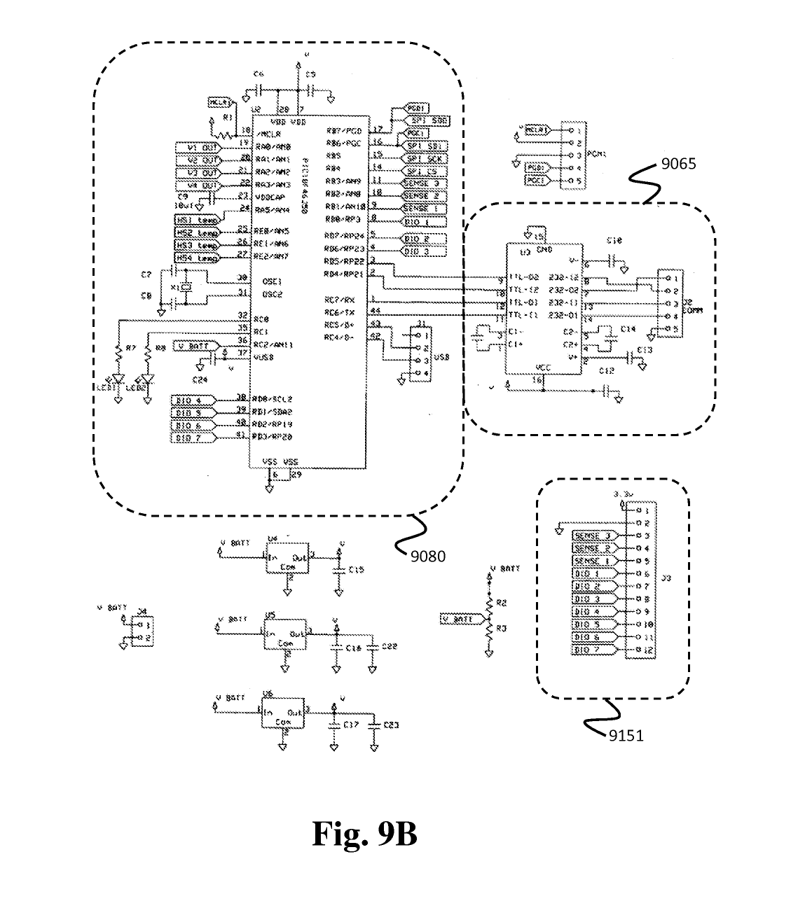

A High Volume Hydrogen Gas system used for trucks and larger vehicles is provided in FIGS. 8 and 9. As shown in FIG. 8, the High Volume system includes power driver module 8000. The power driver module 8000 has filter circuitry 8100 that includes a filter network 8120. The power driver is provided here as buck driver 8150.

The High Volume system also includes a main processor and PWM processor as shown in FIGS. 9A and 9B, respectively. As shown in FIG. 9A, the High Volume system includes multiphase processor 9040 (i.e., main processor) that may be connected to multiple buck drivers (such as buck driver 8150). As shown in FIG. 9B, the High Volume system includes PWM processor 9080 that is connected to communication transceiver 9065 and multiphase processor 9040, and has sensor input 9151 that receives sensor data at the PWM processor 9080.

In the High Volume system of FIGS. 8 and 9, the power driver module 8000 is connected to a 24 V power source. The buck driver 8150 may reduce the 24 V voltage and provide an applied voltage to a hydrogen source that is connected to the High Volume system.

A number of patent and non-patent publications are cited herein in order to describe the state of the art to which this invention pertains. The entire disclosure of each of these publications is incorporated by reference herein.

While certain embodiments of the present invention have been described and/or exemplified above, various other embodiments will be apparent to those skilled in the art from the foregoing disclosure. The present invention is, therefore, not limited to the particular embodiments described and/or exemplified, but is capable of considerable variation and modification without departure from the scope and spirit of the appended claims.

Moreover, as used herein, the term “about” means that dimensions, sizes, formulations, parameters, shapes and other quantities and characteristics are not and need not be exact, but may be approximate and/or larger or smaller, as desired, reflecting tolerances, conversion factors, rounding off, measurement error and the like, and other factors known to those of skill in the art. In general, a dimension, size, formulation, parameter, shape or other quantity or characteristic is “about” or “approximate” whether or not expressly stated to be such. It is noted that embodiments of very different sizes, shapes and dimensions may employ the described arrangements.

It is noted that various sensor values and alarm values represent actual physical conditions of different places and/or different equipment and/or different parts of an installation or vessel or other place, e.g., generally local conditions, that are transformed by the system and method described herein to provide a representation of the overall state and/or condition of the installation, vessel or place, e.g. a representation of the complete installation, vessel and/or place. That representation may be transformative of a representation of a nominal overall state and/or condition thereof, e.g., in a prior or different condition and/or time, to a representation of an actual overall state and/or condition thereof, e.g., in a present or more recent or otherwise different condition and/or time. Further, the system and method generates tasks and commands that are executed to transform the installation, vessel or place into a different configuration, i.e. into a different installation, vessel or place, and a representation of that different configuration is provided or displayed, e.g., to human operators. The system described herein may include one or more general purpose and/or special purpose computers, or microprocessors or other processors, and the method described herein may be performed in part by one or more general purpose and/or special purpose computers, or microprocessors or other processors.

Furthermore, the transitional terms “comprising”, “consisting essentially of” and “consisting of”, when used in the appended claims, in original and amended form, define the claim scope with respect to what unrecited additional claim elements or steps, if any, are excluded from the scope of the claim(s). The term “comprising” is intended to be inclusive or open-ended and does not exclude any additional, unrecited element, method, step or material. The term “consisting of” excludes any element, step or material other than those specified in the claim and, in the latter instance, impurities ordinary associated with the specified material(s). The term “consisting essentially of” limits the scope of a claim to the specified elements, steps or material(s) and those that do not materially affect the basic and novel characteristic(s) of the claimed invention. All systems, devices, and methods described herein that embody the present invention can, in alternate embodiments, be more specifically defined by any of the transitional terms “comprising,” “consisting essentially of,” and “consisting of.”

What is claimed is:

1. A system for providing hydrogen gas to an internal combustion engine, wherein the system is configured to communicate with a hydrogen source that provides hydrogen gas to the internal combustion engine in an amount proportional to an applied voltage, the system comprising:
a. a main processor configured to receive selected data from at least one of a vehicle interface device and an external data source, said main processor configured to generate and transmit a processor signal based on the selected data;
b. a pulse width modulation (PWM) processor in communication with the main processor configured to receive the processor signal, said PWM processor configured to provide a pulse stream based upon the processor signal, wherein the pulse stream comprises a pulse stream time period and a pulse width; and
c. a power driver in communication with the PWM processor and a power source, the power driver configured to receive the pulse stream from the PWM processor and increase or decrease the magnitude of a power source voltage to provide an applied voltage to a hydrogen source; wherein at least one of the main processor and the PWM processor are configured to receive feedback data from a sensor after the provision of an applied voltage to dynamically adjust at least one of the processor signal and pulse stream during operation of the system.

2. The system of claim 1, wherein the vehicle interface device is an on-board diagnostic (OBD) device and the selected data comprises at least one of fuel system status, engine load, engine coolant temperature, short term fuel percent trim, long term fuel percent trim, fuel pressure, intake manifold absolute pressure, engine RPM, vehicle speed, timing advance, intake air temperature, MAF air flow rate, oxygen sensor data, run time since engine start, distance traveled with malfunction indicator lamp on, fuel rail pressure, fuel level, barometric pressure, evaporation system vapor pressure, catalyst temperature, ambient air temperature, throttle position, accelerator pedal position, fuel type, ethanol fuel percent, hybrid battery pack data, fuel injection timing, engine oil temperature, engine torque data, air flow data, diesel intake air flow control and relative intake air flow position, exhaust gas recirculation temperature, exhaust pressure, turbocharger RPM, turbocharger temperature, charge air cooler temperature, exhaust gas temperature, diesel particulate filter temperature, engine run time, or a combination thereof.

3. The system of claim 1, wherein the selected data comprises at least one of engine RPM, engine load, vehicle speed, oxygen sensor data, or a combination thereof.

4. The system of claim 1, wherein the sensor comprises a hydrogen source power sensor, a current rate sensor, a gas rate sensor, a hydrogen source temperature sensor, a hydrogen source unit sensor, an environment temperature sensor, an output voltage sensor, an output current sensor, a hydrogen concentration sensor, or a combination thereof.

5. The system of claim 1, comprising communication circuitry in communication with the main processor, said communication circuitry configured to receive external data from the external data source.

6. The system of claim 5, wherein the communication circuitry comprises recording circuitry configured to record system data onto a non-transitory data storage device.

7. The system of claim 5, wherein the communication circuitry comprises a communications circuitry transceiver configured to transmit at least one of the selected data and feedback data to an external receiver.

8. The system of claim 7, wherein the communications circuitry transceiver comprises an optical transceiver, an electrical transceiver, a radio transceiver, a cellular transceiver, or a combination thereof.

9. The system of claim 1, wherein the main processor comprises a non-transitory computer readable medium having computer readable program code embodied therein, the computer readable program code comprising a look-up table for selection of the processor signal in response to the selected data.

10. The system of claim 9, wherein the main processor is configured to dynamically adjust the look-up table based upon the feedback data received from the sensor after the provision of the applied voltage.

11. The system of claim 1, wherein the power driver comprises a buck driver, a boost driver, a buck-boost driver, or a combination thereof.

12. The system of claim 1, comprising a power source configured to provide a power source voltage of less than 50 volts to the power driver.

13. The system of claim 12, wherein the power driver comprises a buck driver configured to reduce the power source voltage to a magnitude that is less than the power source voltage.

14. The system of claim 12, wherein the power driver comprises a boost driver configured to increase the power source voltage to a magnitude that is greater than the power source voltage.

15. The system of claim 12, wherein the power driver comprises a buck-boost driver configured to increase the power source voltage to a magnitude that is greater than the power source voltage, and decrease the power source voltage to a magnitude that is less than the power source voltage.

16. The system of claim 1, wherein the power driver comprises a plurality of buck drivers, boost drivers, buck-boost drivers, or a combination thereof.

17. The system of claim 1, wherein the power driver comprises a power filter configured to smooth the applied voltage.

18. The system of claim 17, comprising a power filter sensor configured to sense at least one of voltage and current at the power filter, wherein the PWM processor is configured to communicate with the filter sensor and correct any drift in the voltage or current at the filter.

19. The system of claim 1, wherein the hydrogen source comprises an electrolyzer configured to generate hydrogen gas.

20. The system of claim 1, wherein the hydrogen source comprises a hydrogen gas actuator in fluid communication with a hydrogen gas storage, wherein the hydrogen gas actuator is configured to release an amount of hydrogen from the hydrogen gas storage in response to the applied voltage.

21. The system of claim 1, wherein the internal combustion engine comprises a reciprocating engine, a rotary engine, or a continuous combustion engine.

22. The system of claim 1, comprising a safety module in communication with at least one of the engine and hydrogen source, the safety module configured to prevent back flow, vent hydrogen stored at the hydrogen source, or halt production of hydrogen.

23. The system of claim 22, wherein the safety module comprises a valve in communication with the hydrogen source.

24. A method for providing hydrogen gas to an internal combustion engine, the method comprising the steps of:
a. acquiring selected data from a vehicle comprising an internal combustion engine;
b. processing the selected data and comparing the selected data to a look up table to generate a processor signal based on the selected data;
c. producing a pulse stream based on the processor signal, the pulse stream comprising a pulse stream time period and a pulse width;
d. providing a power source voltage to a power driver and changing the magnitude of the power source voltage based on the pulse stream to provide an applied voltage, wherein changing the magnitude of the power source voltage comprises increasing or decreasing the magnitude of the power source voltage;
e. providing the applied voltage to a hydrogen source to produce an amount of hydrogen gas proportional to the applied voltage; and
f. receiving feedback data from a sensor after providing the applied voltage to the hydrogen source, and dynamically adjusting at least one of the processor signal and pulse stream based on the feedback data.

25. The method of claim 24, wherein the step of acquiring selected data comprises acquiring the selected data from at least one of an on-board diagnostic (OBD) device and an external data source.

26. The method of claim 24, wherein the selected data comprises at least one of fuel system status, engine load, engine coolant temperature, short term fuel percent trim, long term fuel percent trim, fuel pressure, intake manifold absolute pressure, engine RPM, vehicle speed, timing advance, intake air temperature, MAF air flow rate, throttle position, oxygen sensor data, run time since engine start, distance traveled with malfunction indicator lamp on, fuel rail pressure, fuel level, barometric pressure, evaporation system vapor pressure, catalyst temperature, ambient air temperature, accelerator pedal position, fuel type, ethanol fuel percent, hybrid battery pack data, fuel injection timing, engine oil temperature, engine torque data, air flow data, diesel intake air flow control and relative intake air flow position, exhaust gas recirculation temperature, exhaust pressure, turbocharger RPM, turbocharger temperature, charge air cooler temperature, exhaust gas temperature, diesel particulate filter temperature, engine run time, or a combination thereof.

27. The method of claim 24, wherein the selected data comprises at least one of engine RPM, engine load, vehicle speed, oxygen sensor data, or a combination thereof.

28. The method of claim 24, comprising the step of transmitting at least one of the selected data and feedback data to an external receiver.

29. The method of claim 28, wherein transmitting comprises at least one of optical transmission, electrical transmission, radio transmission, and cellular transmission.

30. The method of claim 24, comprising the step of storing at least one of the selected data and feedback data onto a non-transitory storage device.

31. The method of claim 24, comprising the step of sensing at least one of a hydrogen source power signal, a current rate signal, a gas rate signal, a hydrogen source temperature signal, a hydrogen source unit signal, an environment temperature signal, an output voltage signal, and a hydrogen concentration signal.

32. The method of claim 24, wherein the step of providing a power source voltage to a power driver comprises the step of filtering and smoothing the applied voltage.

33. The method of claim 32, comprising the step of sensing at least one of voltage and current at a power filter configured to filter and smooth the applied voltage and determine the presence of any drift in the voltage or current at the filter.

34. The method of claim 24, wherein the power source voltage is less than 50 volts.

35. The method of claim 24, wherein the power driver comprises a buck driver, a boost driver, a buck-boost driver, or a combination thereof.

36. The method of claim 24, comprising the step of transmitting the processor signal from a main processor to a pulse width modulation (PWM) processor, wherein the PWM processor is configured to produce the pulse stream.

37. The method of claim 36, wherein the step of transmitting the processor signal from the main processor to the PWM processor comprises electrical transmission, radio transmission, optical transmission, cellular transmission, or a combination thereof.

38. The method of claim 24, further comprising the step of repeating steps a through f.

39. The method of claim 24, wherein the hydrogen source comprises an electrolyzer configured to generate hydrogen gas.

40. The method of claim 24, wherein the hydrogen source comprises a hydrogen gas actuator in fluid communication with a hydrogen gas storage, wherein the hydrogen gas actuator is configured to release an amount of hydrogen from the hydrogen gas storage in response to at the applied voltage.

41. The method of claim 24, wherein the internal combustion engine comprises a reciprocating engine, a rotary engine, or a continuous combustion engine.

42. The method of claim 24, comprising detecting a fault signal at a sensor that indicates the occurrence of an accident or malfunction and transmitting the fault signal to a safety module operably associated with the hydrogen source to, upon reception of the fault signal, halt the production of hydrogen to the internal combustion engine.

43. The method of claim 24, comprising detecting a fault signal at a sensor that indicates the occurrence of an accident or malfunction and transmitting the fault signal to a safety module operably associated with the hydrogen source to, upon reception of the fault signal, vent hydrogen stored at the hydrogen source.
